(19) United States
(12) Patent Application Publication
(10) Pub. No.: US 2014/0359159 A1
(43) Pub. Date: Dec. 4, 2014

(54) FACILITATING UTILIZATION OF DATAGRAM-BASED PROTOCOLS

(71) Applicant: Microsoft Corporation, Redmond, WA (US)

(72) Inventor: GERARDO DIAZ-CUELLAR, KIRKLAND, WA (US)

(21) Appl. No.: 13/916,070

(22) Filed: Jun. 12, 2013

Related U.S. Application Data
(60) Provisional application No. 61/828,660, filed on May 29, 2013.

(51) Int. Cl. H04L 29/06

(52) U.S. Cl. CPC H04L 69/16
USPC 709/235

(57) ABSTRACT

Methods, systems, and computer-storage media for performing a method of facilitating utilization of datagram-based protocols are provided. In embodiments, the method includes initiating a connection with a datagram socket to establish a pathway using a datagram-based protocol. Thereafter, the datagram-based protocol can be used to communicate data to a virtual private network server. Upon recognizing that a virtual private network interface has been idle for a predetermined period of time, a connection with a connection socket is initiated to establish a pathway using a connection-based protocol.

### CROSS-REFERENCE TO RELATED APPLICATIONS

This application claims the benefit of U.S. Provisional Patent Application No. 61/828,660, filed May 29, 2013, entitled “Facilitating Utilization of Datagram-Based Protocols,” which is incorporated by reference herein.

### BACKGROUND

Datagram-based protocols, such as user datagram protocol (UDP), are often used to increase throughput, enhance performance, and/or improve responsiveness. Datagram-based protocols can provide such outcomes, for instance, by reducing or eliminating retransmissions and/or usage of congestion or traffic control algorithms. Utilization of datagram-based protocols, however, can drain the battery life of a user device due to frequent awakening of the user device, or portions thereof. For instance, datagram-based protocols, such as UDP, result in frequent sending of datagrams at short intervals to preserve a communication pathway. To send such datagrams, the user device wakes up, enters a high-powered state, communicates the datagram, and returns to a lower-powered state. Entering and exiting the high-powered state to transmit datagrams diminishes the battery power of the user device.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention relate generally to various implementations for facilitating utilization of datagram-based protocols while preserving battery life of a user device. In this regard, a datagram-based protocol, such as UDP, can be used by a user device to increase performance efficiency while minimizing battery drainage. Embodiments of the present invention generally utilize a datagram-based protocol without communicating keep-alive datagrams at short intervals to preserve a communication pathway. In one implementation described herein, the user device solely uses a datagram-based protocol. In other implementations described herein, the user device uses a datagram-based protocol or a connection-based protocol for communication (e.g., using a single pathway or dual pathways) based on activity of the user device, or portion thereof (e.g., VPN interface or VPN client).

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram illustrating an exemplary system suitable for use in implement embodiments of the present invention;

FIG. 3 is a flow diagram showing a first method for facilitating utilization of a datagram-based protocol in accordance with an embodiment of the present invention;

FIG. 4 is a block diagram illustrating utilization of a single application level pathway in accordance with an embodiment of the present invention;

FIG. 5 is a flow diagram showing a second method for facilitating utilization of a datagram-based protocol in accordance with an embodiment of the present invention;

FIG. 6 is a flow diagram showing a third method for facilitating utilization of a datagram-based protocol in accordance with an embodiment of the present invention; and

FIG. 7 is a flow diagram showing a fourth method for facilitating utilization of a datagram-based protocol in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to facilitating utilization of datagram-based protocols. A datagram-based protocol refers to a network protocol of which computer applications can send messages or datagrams. Using a datagram-based protocol, datagrams can be sent to other devices without prior communications to set up special transmission channels or data paths. A datagram refers to a self-contained, independent entity of data that carries sufficient information to be routed from a source to a destination without relying on previous exchanges between the source, destination, and/or transporting network. In some cases, a datagram might be referred to as a UDP datagram using IP. A datagram-based protocol may also be referred to as a transaction-oriented protocol or a connectionless protocol. In embodiments, a datagram-based protocol may be a user datagram protocol or a universal datagram protocol, referred to as UDP. Although a datagram-based protocol is generally referred to herein as UDP, other datagram-based protocols are included within the scope of embodiments described herein, such as, for instance, protocols related to media streaming, media sharing, chat services, VoIP, email services, or the like.

Traditionally, datagram-based protocols, such as UDP, result in frequent sending of packets at short intervals to preserve a communication pathway. Such packets are referred to as keep-alive datagrams, as described in more detail below. As such, the battery life of a user device can be drained or exhausted due to frequent awakening of the user device, or portions thereof. For example, assume that a user device is not being actively utilized by a user and, as such, is in a low-powered state. Further assume that the user device is utilizing a UDP protocol in a VPN environment. In such a case, upon expiration of a short time interval (e.g., 20 seconds), the user device wakes up, enters a high-powered state, communicates a packet to maintain a pathway or channel, and returns to a lower-powered state. Entering and exiting the high-powered state to transmit such packets diminishes the battery power of the user device, particularly when frequently performed.

Utilizing such datagram-based protocols, however, can be beneficial to increase throughput, enhance performance, and improve responsiveness, for example, by reducing or eliminating retransmissions and congestion/traffic control algorithms (e.g., used by TCP). One particular implementation that can benefit from these performance advantages is virtual private network (VPN) implementations. A VPN extends a private network across public networks, such as the Internet. In this way, a VPN allows a computing device to connect to a remote network(s) to send and receive data across shared or public networks as if part of the private network with the functionality, security, and management policies of the private network. Although various implementations are generally described herein in relation to a VPN environment, embodiments described herein are not intended to be limited in scope and may be applicable to other non-VPN environments.

Embodiments described herein are directed to various implementations for facilitating utilization of datagram-based protocols while preserving battery life of a user device. In this way, a datagram-based protocol, such as UDP, can be employed, at least in some instances, by a user device to increase performance efficiency that might not be achieved by other transport protocols, such as TCP. Additionally, the embodiments described herein facilitate preserving battery life of the user device while utilizing the datagram-based protocol.

Accordingly, in one aspect, an embodiment of the present invention is directed to one or more computer storage media storing computer usable instructions that, when used by one or more computing devices, cause the one or more computing devices to perform a method. The method includes initiating a connection with a datagram socket to establish a pathway using a datagram-based protocol. The method also includes using the datagram-based protocol to communicate data to a virtual private network server. The method further includes recognizing that a virtual private network interface has been idle for a predetermined period of time. Based on the virtual private network interface being idle for the predetermined period of time, a connection with a connection socket is initiated to establish a pathway using a connection-based protocol.

In another aspect, an embodiment of the present invention is directed to a method for facilitating utilization of datagram-based protocols. The method includes establishing a first pathway for using a datagram-based protocol via a datagram socket associated with a user device, and establishing a second pathway for using a connection-based protocol via a connection socket associated with the user device. The first pathway and datagram-based protocol are used to communicate with a virtual private network server. Thereafter, an extent of inactivity associated with the user device is recognized. Based on the extent of inactivity, communicating an indication to the virtual private network server to utilize the connection-based protocol for communications to the user device.

In yet another aspect, an embodiment of the present invention is directed to one or more computer storage media storing computer usable instructions that, when used by one or more computing devices, cause the one or more computing devices to perform a method. The method includes establishing a first pathway with a user device using a user datagram protocol, and establishing a second pathway with the user device using a transmission control protocol, wherein the first pathway and the second pathway coexist. Thereafter, it is identified that a level of inactivity exists within a time frame in association with the user device when the first pathway associated with the user datagram protocol is being used. In accordance with the identified level of inactivity, transferring from utilizing the first pathway and the user datagram protocol to utilizing the second pathway and the transmission control protocol for communications from a virtual private network server to the user device.

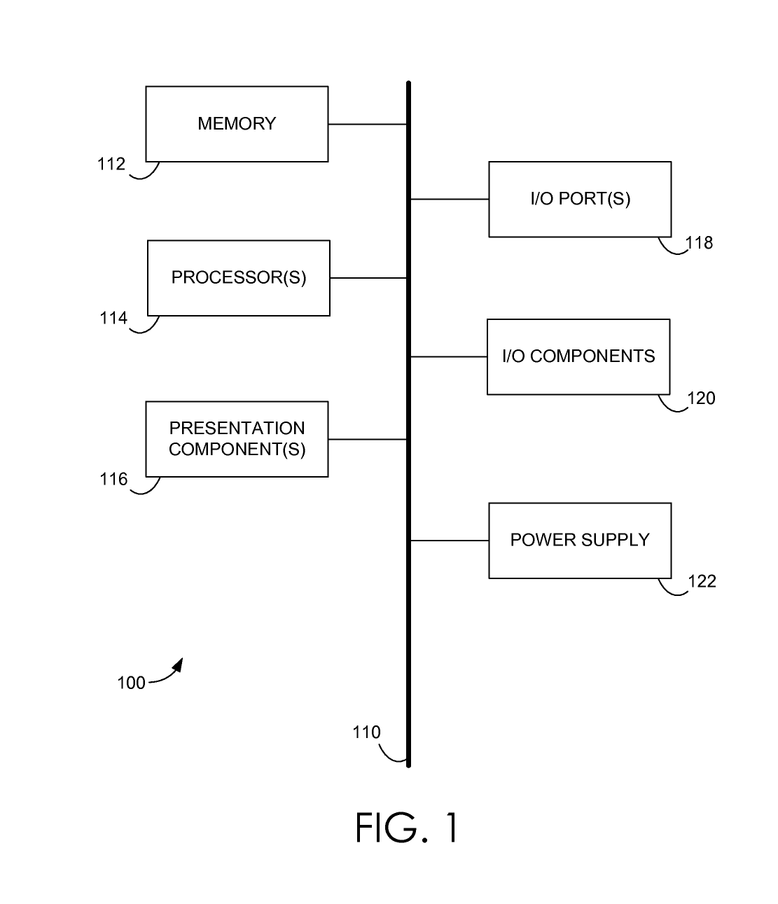

Having described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As defined herein, computer storage media does not include communication media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

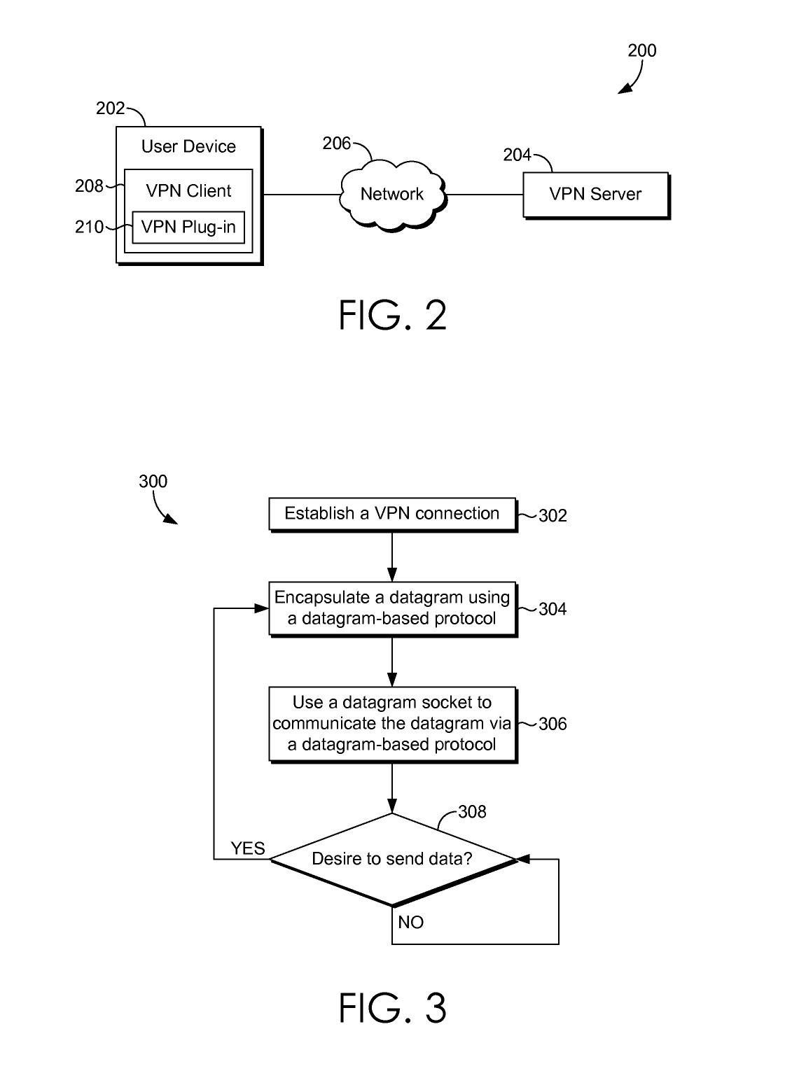

Referring now to FIG. 2, a block diagram is provided illustrating an exemplary system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 200 includes a user device 202 and a VPN server 204. Each of the components shown in FIG. 2 may be any type of computing device, such as computing device 100 described with reference to FIG. 1, for example. The components may communicate with each other via a network 206, which may include, without limitation, one or more local area networks (LANs) and/or wide area networks (WANs). Such networking environments are commonplace in offices, enterprise-wide computer networks, intranets, and the Internet. In embodiments, network 206 may be or include a VPN and/or a public network (e.g., the Internet). As can be appreciated, embodiments of the invention can be employed on top of an existing VPN. That is, a network in which the invention operates could be another VPN in which a user wants to establish a second VPN connection.

It should be understood that any number of user devices and servers may be employed within the system 200 within the scope of the present invention. Each may comprise a single device or multiple devices cooperating in a distributed environment. For instance, the VPN server 204 may comprise multiple devices arranged in a distributed environment that collectively provide the functionality of the VPN server 204 described herein. Additionally, other components not shown may also be included within the system 200.

The VPN server 204 may be any type of computing device that can access a network (e.g., network 206). Although not illustrated, the VPN server 204 can connect with other VPN servers. Generally, the VPN server 204 manages connections to and from the VPN.

The user device 202 may be any type of computing device owned and/or operated by a user that can access network 206. For instance, the user device 202 may be a desktop computer, a laptop computer, a tablet computer, a mobile device, or any other device having network access. Generally, a user may employ the user device 202 to, among other things, access information maintained over the network 206. For example, the user may employ a web browser or application on the user device 202 to access and view electronic documents from one or more content servers. Such content servers may be any type of server device capable of hosting electronic documents and serving the electronic documents to computing devices, such as the user device 202. In some embodiments, the user device 202 is a computing device that is capable of operating via a battery.

In embodiments, the user device 202 is configured to support access to a VPN. In this regard, the user device 202 comprises or includes a VPN client 208 that is capable of accessing a VPN. The VPN client 208 can be installed or integrated with the user device 202. Generally, the VPN client 208 can be used to authenticate users, encrypt data, and/or otherwise manage sessions with VPN servers, such as VPN server 204, utilizing tunneling. In embodiments, the VPN client 208, or a portion thereof (e.g., VPN plug-in 210), enables utilization of a datagram-based protocol. Various implementations described herein permit use of a datagram-based protocol while preserving the battery life of the user device 202.

In some embodiments, the VPN client 208 may be implemented as a stand-alone application. In other embodiments, the VPN client 208 may be implemented via the user device 202 as a part of the operating system, as a web-browser application, or the like. It will be understood by those of ordinary skill in the art that the VPN client 208 illustrated in FIG. 2 is exemplary in nature and in number and should not be construed as limiting. Any number of components, or portions thereof, may be employed to achieve the desired functionality within the scope of embodiments hereof.

The VPN client 208 can include or have access to a VPN plug-in 210. The VPN plug-in 210 can enable utilization of a datagram-based protocol. Although the VPN plug-in 210 is illustrated as part of the VPN client 208, the VPN plug-in 210 can be remote from, but accessible to, to the VPN client 208. The VPN client 208 and the VPN plug-in 210 can be implemented in various ways to enable utilization of a datagram-based protocol. For example, the functionality performed by the VPN plug-in, as described herein, can be integrated with the VPN client 208. In such an implementation, a VPN plug-in performing such functionality is unnecessary. The various implementations described herein are not intended to limit the scope of embodiments of the invention. Alternative or additional embodiments will become apparent to those of ordinary skill in the art to which the present invention pertains without departing from its scope.

As previously described, various implementations described herein are configured to facilitate utilization of a datagram-based protocol in a VPN environment while attempting to preserve battery life of the user device. In one implementation, the VPN plug-in 210 utilizes a datagram socket to enable utilization of a datagram-based protocol. A datagram socket refers to a socket that uses a datagram-based protocol, such as UDP. A datagram socket may also be referred to as a connectionless socket.

In this implementation, upon the user device 202 and/or the VPN client 208 establishing a VPN connection, datagrams or packets are encapsulated for transmission by a datagram socket. In this regard, the datagram-based protocol can be used to encapsulate the datagrams or packets. The datagram socket can then transmit the encapsulated datagrams or packets. Such encapsulation can occur, for example, at the VPN plug-in 210, VPN client 208, and/or the VPN server 204.

A network-address translation device(s) (not shown) can receive the encapsulated datagrams. A network-address translation device can refer to a device on the edge of the network infrastructure in which the user device is connected. In such embodiments, the network-address translation device(s) is not a part of a VPN being used by the user device. In other embodiments, a network-address translation device can be part of or included within the user device.

In some cases, when a network-address translation device receives an encapsulated datagram, the network-address translation device can replace an internal IP address in the source field of the packet header with the external IP address of the network-address translation device, assign a port number, and forward the datagram to the external network. The network-address translation device can make an entry, opening, mapping, or pathway indication in a translation table including, for example, the internal IP address, original source port, and the translated source port. As such, subsequent datagrams using the same VPN communication pathway established by the VPN connection client to the VPN server can be translated to the same port number. Such a translation table can also be used to map a packet coming from the external network to a corresponding internal IP address and port number from the translation table. If the destination port number of the incoming packet is not recognized in the translation table, the packet is dropped or rejected as the network-address translation device cannot identify to which destination to direct the packet. In embodiments, such a pathway may include a source IP address(es), a destination IP address(es), a source port(s), a destination port(s), and/or other data that can be used to identify or differentiate pathways.

When datagrams are transmitted through the datagram socket to the network-address translation device in accordance with a time duration, the entry or opening in the translation table remains active (i.e., an active translation table entry). In this way, the user device, or portion thereof (e.g., VPN client 208), utilizes the datagram-based protocol, such as UDP, to communicate as long as datagrams are transmitted within a predetermined time duration from one another. Such a time duration is referred to herein as an active time duration. An active time duration can be set and/or monitored by the user device 202, the VPN server 204, and/or a network-address translation device. Generally, an active time duration is a short period of time, such as 30 seconds. Further, during the duration of the active translation table entry, inbound communications to the user device responsive to outbound communications from the user device can be appropriately directed to the user device. An inbound communication responsive to an outbound communication can be referred to as correlated inbound communication. As can be appreciated, the user device (or portion thereof), the VPN server, and/or a network-address translation device can monitor traffic activity (e.g., VPN traffic) during an active time duration.

In cases that the user device discontinues or delays transmitting datagrams via the datagram socket for an active time duration (e.g., a predetermined time duration of 30 seconds), the corresponding entry or opening in the translation table can be discarded or become inactive. That is, when a datagram is not transmitted via the datagram socket of the user device within a particular amount of time, the previously generated active translation table entry in the network-address translation device will not be recognized and the datagram will be dropped. In such cases, correlated inbound communications for the specific datagram pathway used (e.g., used by the VPN connection) cannot be directed to the user device. By way of example and without limitation, a response from a server arriving hours after a translation table entry is closed or inactive will not be communicated to the user device. As can be appreciated, for traffic at the VPN interface level, deletion of a translation entry can result in dropping of both correlated traffic and uncorrelated traffic at the interface level.

As previously described, when the active time duration has expired without a datagram being communicated from the user device or portion thereof (e.g., VPN client 208), communications being transmitted to the user device 202, or portion thereof, are dropped as the corresponding entry at the network-address translation device is no longer active. A datagram generated upon closing or inactivating the previously established active translation table entry may be communicated via the datagram socket of the user device 202 to initiate a new pathway or reopen the previous pathway. In this way, datagrams are transmitted using a datagram-based protocol, such as UDP. As can be appreciated, UDP can be utilized for datagrams transmitted in a VPN environment without using keep-alive datagrams. A keep-alive datagram refers to a datagram communicated for the purpose of maintaining datagram-based protocol packet streams. A keep-alive datagram might be an empty UDP datagram or a datagram with minimal and/or non-intrusive content. Generally, keep-alive datagrams are transmitted to maintain a connection or to prevent a connection from being broken such that a network-address translation device does not drop the pathway or indication thereof.

By way of example only and with reference to FIG. 3, a flow diagram is provided that illustrates a method 300 for facilitating utilization of a datagram-based protocol in accordance with an embodiment of the present invention. Such a method can be performed, for example, at a user device, such as user device 202 of FIG. 2, or a portion(s) thereof (e.g., VPN client 208 and/or VPN plug-in 210). As shown at block 302, a VPN connection is established. Thereafter, at block 304, a datagram to be transmitted is encapsulated using a datagram-based protocol. A datagram socket is used to communicate the datagram via a datagram-based protocol, as indicated at block 306. At block 308, a determination is made as to whether additional data is desired to be transmitted. If not, the method continues to return to block 308 until additional data to transmit is identified or the VPN connection is terminated. If additional data is desired for transmission, the method returns to block 304 at which a datagram containing the data is encapsulated using the datagram-based protocol.

As can be appreciated, the datagram-based protocol is utilized without transmitting any keep-alive datagrams. In this regard, when data traffic is reduced during an active time duration thereby resulting in a termination of the datagram-based protocol pathway, the method simply reestablishes or initiates another datagram-based protocol pathway (e.g., UDP pathway) when desiring to transmit data by communicating a datagram via a datagram socket.

Returning to FIG. 2, in another implementation to enable utilization of a datagram-based protocol, the VPN plug-in 210 can selectively utilize a datagram-based protocol and/or a connection-based protocol. For example, in cases that datagrams are communicated from the user device or a portion thereof (e.g., VPN client) within a predetermined period of time (e.g., 25 seconds), the datagram-based protocol can be utilized for communication. Continuing with this example, when a datagram is not transmitted within the predetermined period of time, the connection-based protocol can be used for communication such that incoming or inbound traffic can be received by the user device. A connection-based protocol refers to network protocol in which a communication session or a connection is established before useful data is transferred. Generally, in connection-based protocols, a stream of data is delivered in the same order in which it was sent. An exemplary connection-based protocol is transmission control protocol (TCP), but embodiments described herein can be any connection-based protocol and are not limited to TCP.

In operation, a single application level pathway, logical link, or channel is used to facilitate use of a datagram-based protocol, when appropriate. Initially, the VPN plug-in 210 connects with a datagram socket. Although the initially established pathway described herein utilizes a datagram-based protocol, as can be appreciated, in other embodiments, the user device can initially use a connection-based protocol, such as TCP.

The user device, or portion thereof such as the VPN client 208 and/or VPN plug-in 210, can monitor and/or track traffic being sent via the user device 202, VPN client 208, and/or VPN plug-in 210 (e.g., over a VPN interface). Upon detecting, identifying, or recognizing that data has not be sent for an active time duration (e.g., the VPN interface has been idle for 25 seconds), the VPN plug-in 210 can be notified and/or recognize such an inactive period and thereby request usage of a connection-based protocol. Stated differently, when a low activity period is identified (e.g., due to little to no datagrams being sent during a time period), the VPN plug-in 210 can be notified of such and, thereafter, initiate a switch from using a datagram socket (e.g., UDP socket) to a connection socket (e.g., TCP socket). In embodiments, a pathway is established using the connection-based protocol, such as TCP, when the VPN interface is idle for an active time duration indicating inactivity and not necessarily when the entire user device is idle. Utilizing a connection-based protocol to establish a pathway will assure that responses directed to the user device can be received at any time, that is, even during a period of low activity. As such, in cases that a user device, or an application thereof (e.g., VPN client 208), is in a low activity or idle mode, the user device can still receive data, such as incoming voice calls, incoming emails, incoming operating system or application updates, or the like. By way of example only, user interface tiles can be delivered through VPN to provide updates even when in connected standby and other low-powered states.

Upon detecting an increase in traffic or a level of traffic, utilization of the datagram-based protocol can be resumed or initiated for use in communicating. In some embodiments, a traffic increase or traffic level might be detected based solely on an increase in outgoing traffic from the user device. In other embodiments, a traffic increase or level might be detected based solely on an increase in incoming traffic to the user device or based on an increase in both incoming and outgoing traffic. Further, an increase in traffic or a level of traffic considered sufficient for transferring to the datagram-based protocol can be any amount or level. For example, in some cases, a traffic threshold or level might be exceeded when a rate sufficient to keep a translation table entry at a network address translation device open or alive (e.g., greater than 1 packet per 25 seconds). Utilizing a greater traffic threshold for exceeding before transferring to a datagram-based protocol can minimize the number of instances resulting in switching between protocols, and thereby ensure that the datagram-based protocol is used for periods of time during which traffic rates are higher.

Transferring to the datagram-based protocol can occur in any number of manners or methods and is not intended to limit the scope of embodiments described herein. For example, in one embodiment, a debounce timeout might be used to terminate or end the connection using the connection-based protocol. In this way, rate-limiting or throttling might be used to discontinue use of the connection-based protocol. The VPN plug-in 210 can then initiate a switch to or utilization of a datagram socket to thereby utilize the datagram-based protocol. As can be appreciated, the connection-based protocol may be used for a maximum amount of time or a minimum amount of time (e.g., to avoid frequent switching).

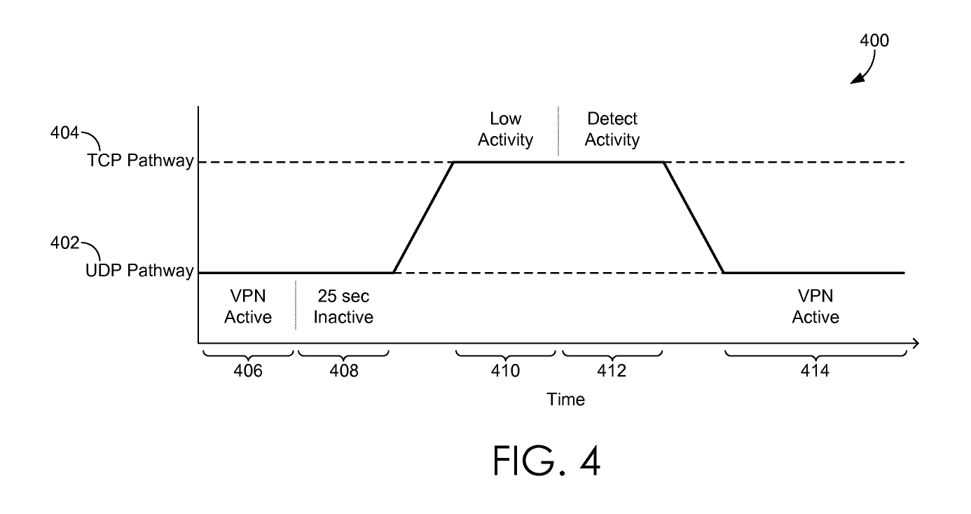

FIG. 4 illustrates utilization of a single application level pathway using a UDP pathway 402 that is transferred to a TCP pathway 404. As illustrated at time duration 406, the UDP pathway 402 is initially established for communications. During the time duration 406, the VPN is active, for example, as indicated by data traffic being sent over a VPN interface. During the time duration 408, however, a period of inactivity is detected. As a result, the use of UDP is terminated, and the TCP pathway 404 is initiated. Accordingly, as illustrated at time duration 410, the TCP pathway is utilized for communications during a time of low activity by the user device, or portion thereof. For example, the time duration 410 may correspond with the period of time during which one or less packets are transmitted over a VPN interface per a 25 second period of time. Now assume that, at time duration 412, the activity level increases. For instance, an increase of traffic to and/or from the VPN interface is detected.

As previously described, the traffic increase or traffic level can be measured in any number of ways, such as exceeding an inbound traffic threshold, exceeding an outbound traffic threshold, exceeding a total traffic threshold (e.g., including inbound and outbound traffic). Further, such a traffic increase or level might be related to the user device, to the operating system of the user device, to the VPN client (e.g., as indicated by a VPN interface), or the like. Upon detecting the increased activity level, the use of TCP is terminated, and the UDP pathway 404 is initiated or resumed. Accordingly, as illustrated at time duration 414, the UDP pathway is utilized for communications during a time in which the VPN is again active.

Using a single application level channel, logical link, or pathway to switch between a datagram-based protocol and a connection-based protocol, when appropriate, provides coverage for various scenarios, such as outbound connections, long idle connections, and correlated and uncorrelated connections while preserving battery life of the user device.

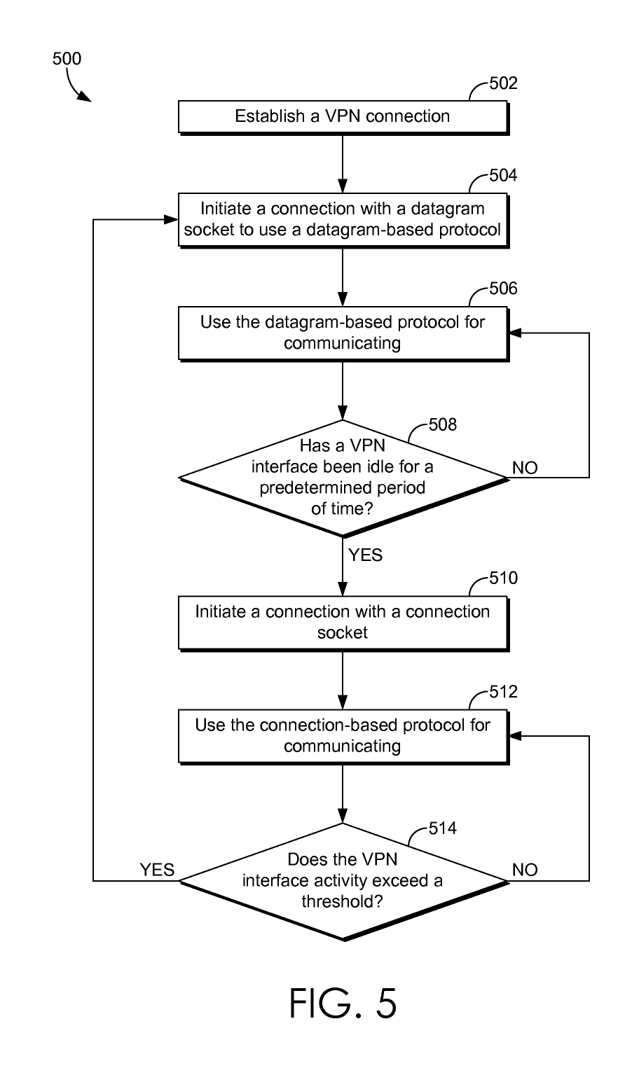

By way of example and with reference to FIG. 5, a flow diagram is provided that illustrates a method 500 for facilitating utilization of a datagram-based protocol in accordance with an embodiment of the present invention. Such a method can be performed, for example, at a user device, such as user device 202 of FIG. 2, or a portion(s) thereof (e.g., VPN client 208 and/or VPN plug-in 210). Initially, as shown at block 502, a VPN connection is established. At block 504, a datagram socket is connected with to use a datagram-based protocol. Thereafter, at block 506, the datagram-based protocol can be used for data communications.

At block 508, a determination is made as to whether a VPN interface has been idle for a predetermined period of time. Such a determination can be made in any manner and time. For example, such a determination may be made periodically (e.g., upon a lapse of the predetermined period of time), upon an occurrence of an event, or the like. The parameters regarding idle or activity level can vary and may be established the user, VPN developer or provider, or the like. If the VPN interface has not been idle for a predetermined period of time (i.e., has been active within the time period), the method continues at block 506 to use the datagram-based protocol for communication. If, however, the VPN interface has been idle or inactive for the predetermined period of time, the method continues to block 510 at which a connection with a connection socket is initiated. Thereafter, the connection-based protocol can be used for communications, as indicated at block 512. As such, emails, updates, phone calls, notifications, etc. can be received even when in a low-powered state or mode.

At block 514, a determination is made as to whether the VPN interface activity exceeds a threshold. Such a determination can be made in any manner and time. For example, such a determination may be made periodically (e.g., upon a lapse of the predetermined period of time), upon an occurrence of an event, or the like. Further, the threshold can be any activity level or activity increase and associated with, for instance, outbound communications and/or inbound communications. If it is determined that the VPN interface activity does not exceed a threshold, the method continues with block 512 to utilize the connection-based protocol. On the other hand, if the VPN interface activity exceeds a threshold, the method continues to block 504 at which connection with a datagram socket is initiated to use the datagram-based protocol for communications.

Referring again to FIG. 2, in yet another implementation to enable utilization of a datagram-based protocol, the VPN plug-in 210 can utilize dual channels or pathways. In such an implementation, the VPN plug-in 210 can specify or enable specification of two sockets, namely, a datagram socket associated with a datagram-based protocol and a connection socket associated with a connection-based socket. By way of example, the user device 202 and/or the VPN client 208 allow the VPN plug-in 210 to specify two sockets in the AssociateTransport( ) and in the Start( )method. In embodiments, the datagram socket is the primary socket utilized for communication being transmitted from the user device. In this way, the datagram-based protocol will be used as often as possible.

The VPN plug-in 210 initiates a connection with both the datagram socket and the connection socket. In this regard, the user device 202, or portion thereof, establishes a first pathway with the VPN server 204 using a datagram-based protocol via the datagram socket and a second pathway with the VPN server 204 using a connection-based protocol via the connection socket. Upon transmitting data traffic, a network-address translation device(s) can create a mapping associated with the datagram-based protocol (a short-lived mapping) and/or a mapping associated with the connection-based protocol (a long-lived mapping). Initial communications are transmitted using the datagram socket and thereby the datagram-based protocol. Although the initial communications described herein utilize a datagram-based protocol, as can be appreciated, in other embodiments, the user device can initially use a connection-based protocol, such as TCP.

The user device, or portion thereof such as the VPN client 208, and/or the VPN server 204 can monitor and/or track traffic being sent via the user device 202 or VPN client 208 (e.g., over a VPN interface or datagram pathway, such as UDP). Upon detecting that data traffic has not be sent for a predetermined time duration (e.g., the VPN interface or UDP pathway has been idle for 25 seconds), the VPN server 204 can switch to utilize the connection-based protocol. In cases that the user device 202, or portion thereof, detects the traffic inactivity, the user device can notify the VPN server 204 to request usage of the connection-based protocol. In cases that the VPN server 204 performs the detection of traffic inactivity, the VPN server 204 can trigger the switch to utilize the connection-based protocol. The manner of switching to the connection-based protocol can be performed in any manner and is not intended to limit the scope of embodiments described herein.

Upon the VPN server 204 transferring to use the connection-based protocol, subsequent packets received at the VPN server 204 and directed to the user device can utilize the connection-based protocol. As such, the user device 202 can receive data via the connection-based protocol even when the VPN is in an inactive state. The VPN server 204 can utilize the connection-based protocol to deliver data to the user device 202 in any manner.

In one embodiment, the VPN server 204 encapsulates the data payload in a connection socket. The VPN plug-in 210 at the user device 202 can then decapsulate the payload and deliver the packet. The VPN plug-in 210 can also provide instructions that the response to such payload should be delivered over UDP to continue the communication and reopen the flow again for further data path traffic.

In another embodiment, the VPN server 204 sends a ping detection control payload to the VPN client 208 via the VPN plug-in 210. The VPN plug-in 210 can then provide instructions that the response to the control packet should be sent over the UDP transport. When the VPN server 204 receives a ping response over UDP, the server can deliver the outgoing payload over UDP.

In response to the user device 202, or portion thereof, receiving data via the connection-based protocol, the user device 202 can reply using the datagram-based protocol. In this regard, the VPN plug-in 210 initiates use of the datagram socket to communicate using the datagram-based protocol. As such, a network-address translation device can reestablish or initiate a translation mapping in association with the datagram-based protocol. Similarly, if the user device 202 acquires or obtains data to communicate, the VPN plug-in 210 can initiate use of the datagram socket to communicate using the datagram-based protocol.

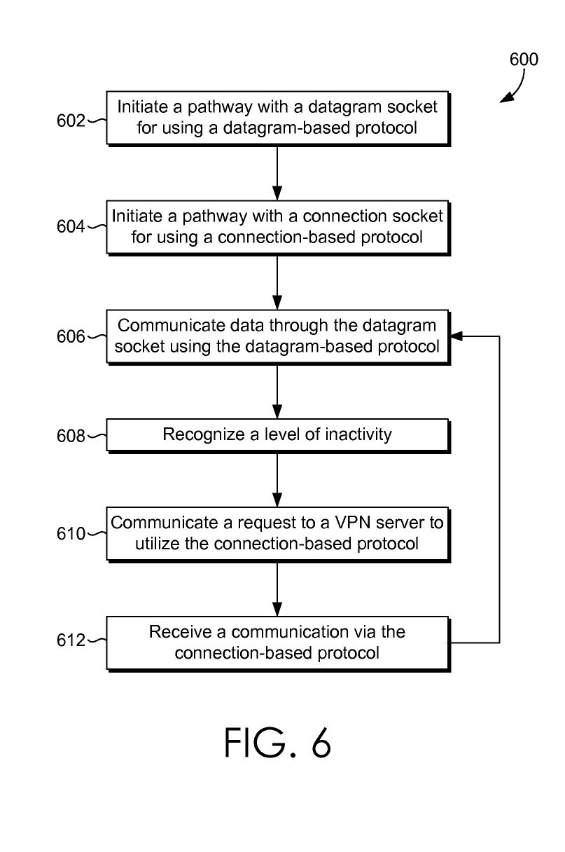

Turning to FIG. 6, a flow diagram is provided that illustrates another method 600 for facilitating utilization of a datagram-based protocol in accordance with an embodiment of the present invention. Such a method can be performed, for example, at a user device, such as user device 202 of FIG. 2, or a portion(s) thereof (e.g., VPN client 208 and/or VPN plug-in 210). Initially, as shown at block 602, a pathway for using a datagram-based protocol is initiated with a datagram socket. At block 604, a pathway for using a connection-based protocol is initiated via a connection socket. Subsequently, at block 606, data is communicated through the datagram socket using the datagram-based protocol. At block 608, a level of inactivity is recognized. For example, a VPN interface or a UDP pathway may not be utilized during a period of time. At block 610, a request is communicated to the VPN server to utilize the connection-based protocol. As can be appreciated, in some embodiments, the VPN server may perform such monitoring and, as such, blocks 608 and/or 610, are not performed at the user device. At block 612, a communication is received via the connection-based protocol. The method can then proceed to block 606 at which any new data can be communicated through the datagram socket using the datagram-based protocol. In this way, when the device, or portion thereof, is in a low-powered state, data can be received, for example, via TCP. However, when the device is ready to actively communicate data, the datagram socket can be used to communicate using a datagram-based protocol, such as UDP.

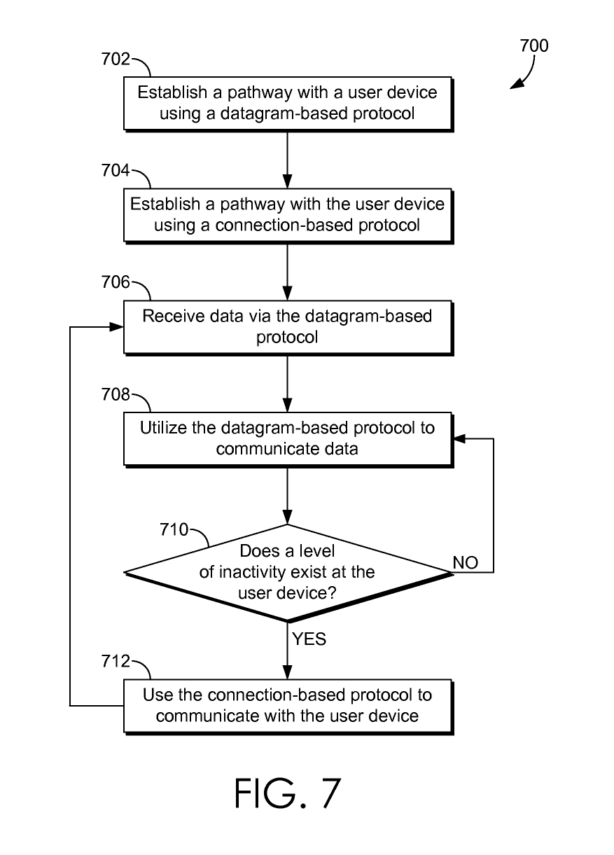

With reference to FIG. 7, a flow diagram is provided that illustrates another method 700 for facilitating utilization of a datagram-based protocol in accordance with an embodiment of the present invention. Such a method can be performed, for example, at a VPN server, such as VPN server 204 of FIG. 2. Initially, as indicated at block 702, a pathway with a user device is established using a datagram-based protocol. At block 704, a pathway with the user device is established using a connection-based protocol. As such, the user device and the VPN server can communicate using either pathway. At block 706, data is received via the datagram-based protocol. Subsequently, at block 708, the datagram-based protocol is utilized by the VPN server to communicate data.

At block 710, a determination is made as to whether a level of inactivity exists at the user device, or a portion thereof (e.g., a VPN client). Such a determination may be made, for example, based on monitoring at the VPN server and/or based on a notification provided by the user device or other component. If a level of inactivity does not exist (i.e., the user device, or portion thereof is active), the method returns to block 708 and continues to use the datagram-based protocol to communicate data. On the other hand, if a level of inactivity does exist, at block 712, the connection-based protocol is used to communicate with the user device. As such, the user device can receive data even when in a low-powered state. Thereafter, the VPN server can continue to use the connection-based protocol to communicate with the user device until the server receives data from the user device via the datagram-based protocol, at which time the VPN server would switch to utilizing such a protocol. This is indicated at blocks 706 and 708.

As can be appreciated, each of the implementations described herein facilitate use of a datagram-based protocol, such as UDP, in a VPN environment without utilizing keep-alive datagrams. As a result, the advantages of datagram-based protocols can be achieved without draining the battery of the user device due to entering and exiting a high-powered state to deliver the keep-alive datagrams. Further, some implementations can create and destroy connection-based protocol pathways as needed, while other implementations initiate and end utilization of an established connection-based protocol pathway as needed.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer usable instructions that, when used by one or more computing devices, cause the one or more computing devices to perform a method, the method comprising:
initiating a connection with a datagram socket to establish a pathway using a datagram-based protocol;
using the datagram-based protocol to communicate data to a virtual private network server;
recognizing that a virtual private network interface has been idle for a predetermined period of time; and
based on the virtual private network interface being idle for the predetermined period of time, initiating a connection with a connection socket to establish a pathway using a connection-based protocol.

2. The media of claim 1, wherein the datagram-based protocol comprises a user datagram protocol.

3. The media of claim 1, wherein the connection-based protocol comprises a transmission control protocol.

4. The media of claim 1, wherein the recognition that the virtual private network interface has been idle for the predetermined period of time occurs when the datagram-based protocol is being utilized.

5. The media of claim 1, wherein the recognition that the virtual private network interface has been idle for the predetermined period of time occurs when the virtual private network interface has not been used to communicate a data packet with the predetermined period of time.

6. The media of claim 1, wherein the recognition that the virtual private network interface has been idle for the predetermined period of time occurs when the virtual private network interface has not been used to receive or communicate a data packet with the predetermined period of time.

7. The media of claim 1, wherein upon initiating the connection with the connection socket to establish the pathway, the connection-based protocol is used for communication.

8. The media of claim 7, wherein the connection-based protocol is used for communication until the virtual private network interface is used to communicate a new data packet.

9. A method for facilitating utilization of datagram-based protocols, the method comprising:
establishing a first pathway for using a datagram-based protocol via a datagram socket associated with a user device;
establishing a second pathway for using a connection-based protocol via a connection socket associated with the user device;
utilizing the first pathway and datagram-based protocol to communicate with a virtual private network server;
recognizing an extent of inactivity associated with the user device; and
based on the extent of inactivity, communicating an indication to the virtual private network server to utilize the connection-based protocol for communications to the user device.

10. The method of claim 9, wherein the extent of inactivity associated with the user device is recognized based on less than a threshold number of data communications being transmitted from the user device within a predetermined period of time.

11. The method of claim 9, wherein the extent of inactivity associated with the user device is recognized based on less than a threshold number of data communications being transmitted from or received by the user device within a predetermined period of time.

12. The method of claim 9 further comprising receiving a data packet using the connection-based protocol from the virtual private network server upon the extent of inactivity.

13. The method of claim 9 further comprising:
determining that a new data packet is to be communicated from the user device to the virtual private network server upon communicating the indication to the virtual private network server to utilize the connection-based protocol for communications to the user device; and
in accordance with the determination, communicating the new data packet through the datagram socket using the datagram-based protocol.

14. The method of claim 9, wherein the datagram-based protocol comprises a user datagram protocol.

15. The media of claim 9, wherein the connection-based protocol comprises a transmission control protocol.

16. One or more computer storage media storing computer usable instructions that, when used by one or more computing devices, cause the one or more computing devices to perform a method, the method comprising:
establishing a first pathway with a user device using a user datagram protocol;
establishing a second pathway with the user device using a transmission control protocol, wherein the first pathway and the second pathway coexist;
identifying that a level of inactivity exists within a time frame in association with the user device when the first pathway associated with the user datagram protocol is being used; and
in accordance with the identified level of inactivity, transferring from utilizing the first pathway and the user datagram protocol to utilizing the second pathway and the transmission control protocol for communications from a virtual private network server to the user device.

17. The media of claim 16, wherein the identification that the level of inactivity exists is made based on a notification provided by the user device.

18. The media of claim 16, wherein the identification that the level of inactivity exists is made based on monitoring performed at the virtual private network server.

19. The media of claim 16, wherein the virtual private network server continues to use the second pathway and the transmission control protocol to communicate data to the user device until the virtual private network server receives data from the user device via the first pathway and the user datagram protocol.

20. The media of claim 19 further comprising transferring from the second pathway and the transmission control protocol to the first pathway and user datagram protocol to communicate data to the user device when the virtual private network server receives data from the user device via the first pathway and the user datagram protocol.
